(19) United States
(12) Patent Application Publication
(10) Pub. No.: US 2004/0148737 A1
(43) Pub. Date: Aug. 5, 2004

(54) Vehicle door-to-body attachment apparatus and method

(76) Inventors: Mark R. Dunneback, Macomb Township, MI (US); David R. Carr, Novi, MI (US); Timothy J. Brunk, Shelby Township, MI (US)

Correspondence Address: Donald J. Wallace, DaimlerChrysler Intellectual Capital Corporation, CIMS 483-02-19, 800 Chrysler Drive, Auburn Hills, MI, 48326-2757, US

(21) Appl. No.: 10/355,569

(22) Filed: Jan. 31, 2003

(51) Int. Cl. E05D 3/02

(52) U.S. Cl. 16/221

(57) ABSTRACT

A method for mounting a door to a vehicle body without the aid of a door-to-body mounting fixture. The method utilizes statistical process control data from previously assembled doors to determine the locations of holes that are pierced in hinges just prior to hinge installation. A pair of hinges are provided with the pierced holes to ensure self-alignment of the door.

### FIELD OF THE INVENTION

The present invention relates to a method and apparatus for attaching a door to a vehicle body.

### BACKGROUND OF THE INVENTION

In automotive assembly, hinges are typically provided with oversized holes to allow for dimensional variations in manufacturing of the hinges, doors, vehicle body and hole locations. Briefly, a typical automotive door hinge has an upper and a lower hole used to attach a door to the hinge. Typically, each of these holes are oversized to allow for manufacturing tolerances. In this manner, the door can be adjusted relative to the hinges to properly position the door relative to the body.

A typical method for attaching a door to a vehicle involves positioning a pair of hinges relative the body with a hinge-to-body fixture and attaching the hinges to the body. A door-to-hinge (body) fixture is then used to properly position the door relative the body and the door is then attached to the hinges.

The door-to-body fixture requires set-up time and expense to ensure proper positioning of the door. These expenses can include manpower, specialized fastening items, and equipment. The door typically includes threaded mounting studs or nuts that are welded to the door to complement the general location of the oversized, or clearance, holes in the hinges when the hinges are attached to the body. When the door is aligned to the body and the studs or nuts are aligned within the clearance holes, a washer is placed over each clearance hole and an appropriate fastening element installed at each fastening location. Current manufacturing methods require that, after painting of the door and body together, the door is then removed to facilitate final assembly of the door and vehicle interior. The door is then reattached to the body.

One typical method for ensuring that the door-to-body re-attachment does not require the door-to-body fixture is disclosed in commonly owned U.S. Pat. No. 6,178,599, wherein the hinge pins can be removed from hinges, thus separating the door from the body.

Another typical method for ensuring that the door-to-body re-attachment does not require the door-to-body fixture involves affixing washers to the hinges in conjunction with the initial installation with the fixture. In this method, shoulder studs connected to the doors extend through the clearance holes in the hinges and size-on-size (closely fitting) holes in the washers. The washers can be welded to the hinge or a high strength adhesive applied between the hinge and washer. When the washers are affixed to the hinges, the doors can be detached from the hinges and later re-attached in the same position without the aid of a door-to-body fixture. The mating surface of the nut is recessed around the threaded opening to accommodate the non-threaded shoulder of the stud that protrudes through the washer. In this manner, the mating surface of the nut contacts the washer to properly secure the hinge to the door.

While the prior art assembly methods have performed satisfactorily, the continued development of vehicle assembly methods have been directed toward developing methods that produce a more consistent result, eliminate or reduce specialized assembly items and equipment, and reduce manpower requirements.

What is needed is a method for attaching a door to a vehicle body hinge that does not require a door-to-body fixture, requires less hardware, and can allow the door to be removed and reinstalled without the need for a door-to-body fixture.

### SUMMARY OF THE INVENTION

The present invention provides a method for mounting a door to a vehicle body without the use of a mounting fixture.

In one aspect, the present invention provides a pair of hinges with one door mounting clearance aperture within each hinge. The remainder of the door mounting holes are pierced in the hinge just prior to hinge installation. The location of each piercing is determined through an analysis of statistical process control data collected from previously installed doors. The pierced aperture in the upper hinge is a size-on-size hole that accommodates a fastener diameter without significant additional diameter for adjustment of the door relative to the hinge. The pierced aperture in the lower hinge is an elongated slot with a minor diameter that is slightly larger than the fastener diameter. The orientation of the elongated slot is such that a line defining its major diameter intersects the other door mounting holes within the pair of hinges. The hinges are attached to the vehicle body using a hinge-to-body fixture to ensure proper positioning of the hinges relative the body and the door is then attached to the hinges. The size-on-size hole and the elongated slot ensure that the door is properly positioned relative the body after the door-to-hinge attachment. In this manner, welding, adhesives, recessed nuts and door-to-body fixtures are not required to mount the door to the body of a vehicle.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a portion of a vehicle in accordance with a preferred embodiment of the present invention; and

FIG. 2 is a perspective view illustrating the hinges of FIG. 1.

### DETAILED DESCRIPTION OF THE PREFERRED EMBODIMENTS

The following description of the preferred embodiment(s) is merely exemplary in nature and is in no way intended to limit the invention, its application, or uses.

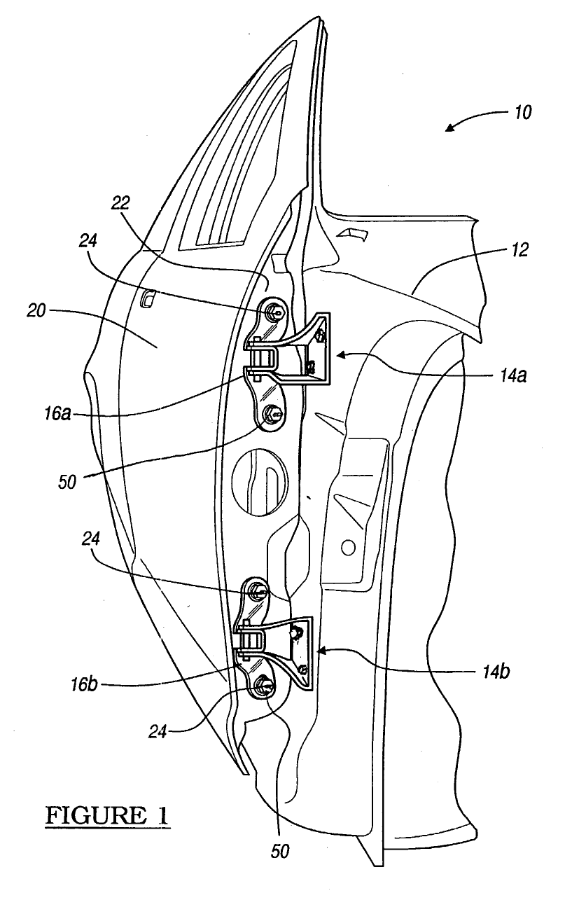

With reference to FIG. 1, an exemplary vehicle is generally indicated by reference numeral 10. The vehicle 10 includes a body 12 with hinge mounting connections 14a, 14b. A hinge-to-body fixture (not shown) is used to properly position the hinges 16a 16b, relative the body 12 and hinges 16a, 16b are fastened to hinge mounting connections 14a, 14b.

A door 20 is shown fastened to hinges 16a, 16b. Door 20 includes a mounting panel 22 and threaded mounting studs 24 located on mounting panel 22. Preferably, mounting studs 24 are not adjustable with respect to door 20.

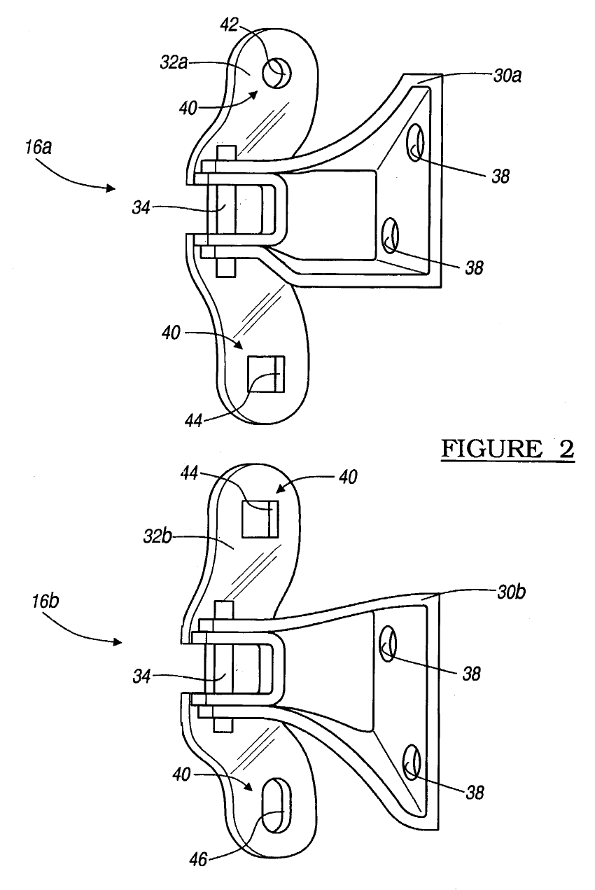

With reference to FIG. 2, a pair of hinges 16a, 16b are shown wherein each hinge 16a, 16b includes a first member 30a, 30b and a second member 32a, 32b. First and second members 30a, 30b and 32a, 32b are rotatably connected with a pin 34. First member 30a, 30b preferably includes two vehicle mounting apertures 38. Second member 32a, 32b preferably includes two door mounting apertures 40. Upper hinge 16a is shown to include first member 30a and a second member 32a with a size-on-size door mounting aperture 42 and a door mounting clearance aperture 44 formed therein. Size-on-size door mounting aperture 42 is adapted to accommodate mounting stud 24 without significant additional diameter for adjustment of door 20 relative to hinge 16a. Door mounting clearance aperture 44 is adapted to accommodate mounting stud 24 while providing additional diameter for adjustment of door 20 relative to hinge 16a.

Lower hinge 16b is shown in a preferred embodiment to include first member 30b and second member 32b with a door mounting clearance aperture 44 and an elongated aperture 46 formed therein. Elongated aperture 46 is adapted to accommodate a mounting stud 24 while providing clearance in one direction. Stud 24 received in elongated aperture 46 provides an anti-rotation function of the door 20 about size-on-size aperture 42.

With reference to FIGS. 1 and 2, upper hinge 16a is attached to an upper hinge mounting connection 14a. Lower hinge 16b is attached to a lower hinge mounting connection 14b. When hinges 16a, 16b are positioned adjacent hinge mounting connections 14a, 14b with a hinge-to-body fixture, hinges 16a, 16b are fastened to hinge mounting connections 14a, 14b. In this manner, hinges 16a, 16b are properly positioned with respect to body 12. Mounting studs 24 are disposed through door mounting apertures 40 and a fastening element 50 is coupled to each mounting stud 24. Fastening element 50 is preferably a nut. Mounting studs 24 are essentially non-adjustable with respect to size-on-size door mounting aperture 42 and elongated aperture 46. In this manner, door 20 is properly positioned with respect to body 12 as mounting studs 24 are positioned within size-on-size door mounting aperture 42 and elongated aperture 46 and, therefore, a door-to-body fixture (not shown) is not required. Elongated aperture 46 provides limited vertical adjustability for the attachment of lower hinge 16b to lower hinge mounting connection 14b, but does not provide adjustment of door 20 inwardly or outwardly with respect to body 12.

Hinges 16a, 16b are prefabricated with vehicle mounting apertures 38 and clearance apertures 44 prior to staging at the assembly line. Size-on-size door mounting aperture 42 and elongated aperture 46 are cut within hinges 16a, 16b as vehicles 10 are assembled on the assembly line. The apparatus (not shown) used to form apertures 42, 46 is preferably adjustable such that the locations within hinges 16a, 16b for apertures 42, 46 can be infinitely adjusted as feedback is received from the line.

After doors 20 are attached to body 12, measurements are taken to determine the variation from the desired fit and finish provided in the building specification. While the individual building specification provides the location for these measurements, these locations are preferably taken at each hinge location and at least one additional location such as a latch point. The measurements are collected as process control data. The data collected from each vehicle measured is used to determine the trends (if any) in variation of fit and finish. When a trend is identified, an adjustment is made to the apparatus that cuts size-on-size door mounting aperture 42 and/or elongated aperture 46. In this manner, the fit of door 20 relative to body 12 can be adjusted on the line to ensure that the variation in fit does not exceed the allowable values found in the building specification.

Additional work, such as welding or attaching a washer to hinge 16a, 16b is not required and hinges with removable pins are not needed to enable removal and reinstallation of door 20 without a door-to-body fixture. Since washers are not required to fasten and align door 20 to hinges 16a, 16b fastening element 50 is not required to be a recessed nut in order to ensure proper fastening contact between fastening element 50 and second member 32a, 32b.

While door mounting panel 22 is depicted with attached studs and fastening element 50 is preferably a nut, one of ordinary skill in the art would appreciate that alternative fastening means, such as members with threaded apertures fixed on door mounting panel 22 and a fastening element 50 that is a bolt or a screw, could also be used to fasten door 20 to hinges 16.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for attaching a door to a vehicle without the aid of a door-to-body alignment fixture comprising the steps of:
providing an upper hinge, wherein the upper hinge includes a first upper member defining a plurality of vehicle mounting apertures and a second upper member defining a door mounting clearance aperture, and wherein the first and second upper members are pivotally connected;
providing a lower hinge, wherein the lower hinge includes a first lower member defining a plurality of vehicle mounting apertures and a second lower member defining a door mounting clearance aperture, and wherein the first and second lower members are pivotally connected;
forming a size-on-size door mounting aperture within the second upper member;
forming an elongated door mounting aperture within the second lower member;
positioning the first upper member adjacent an upper hinge mounting connection;
positioning the first lower member adjacent a lower hinge mounting connection, the upper and lower hinge mounting connections being located on the vehicle and the steps of positioning the first upper and first lower members being accomplished with the use of a hinge-to-body fixture;
fastening the first upper member to the upper hinge mounting connection;
fastening the first lower member to the lower hinge mounting connection;
providing a door having a plurality of mounting studs configured to align with the door mounting apertures;
locating the mounting studs within the door mounting apertures; and
fastening a plurality of fastening elements to the plurality of mounting studs to attach the door to the vehicle.

2. The method of claim 1, further comprising the steps of:
collecting fit data from a previous assembly; and
determining the desired location for forming at least one of the size-on-size door mounting aperture and the elongated door mounting aperture.

3. A door to body mounting assembly for attaching a door to a vehicle comprising:
an upper hinge, including a first upper member defining a plurality of vehicle mounting apertures and a second upper member defining a door mounting clearance aperture and a size-on-size door mounting aperture, wherein the first and second upper members are pivotally connected; and
a lower hinge including a first lower member defining a plurality of vehicle mounting apertures and a second lower member defining an elongated door mounting aperture and a door mounting clearance aperture, wherein the first and second lower members are pivotally connected.

4. A method for attaching doors to vehicles on an assembly line, comprising the steps of:
providing a hinge having a first member pivotally connected to a second member;
forming an aperture in the second member;
assembling a door to a vehicle body by attaching the first member to the vehicle body and the second member to the door, wherein the second member is attached to the door by a fastener passing through the aperture in the second member;
collecting alignment data from an assembled door and vehicle body;
determining an adjusted position for the aperture using the alignment data; and
controlling an apparatus for forming the aperture in the adjusted position in subsequent second members.
